(19) United States
(12) Patent Application Publication
(10) Pub. No.: US 2024/0286845 A1
(43) Pub. Date: Aug. 29, 2024

(54) AXLE OR SHAFT

(71) Applicant: Schindler Holding GmbH & Co KG, Pluederhausen (DE)

(72) Inventor: Jens SCHINDLER, Pluederhausen (DE)

(73) Assignee: Schindler Holding GmbH & Co KG, Pluederhausen (DE)

(21) Appl. No.: 18/584,055

(22) Filed: Feb. 22, 2024

(30) Foreign Application Priority Data
Feb. 27, 2023 (DE) 10 2023 104 700.0

(51) Int. Cl. B65G 23/02

(52) U.S. Cl. CPC B65G 23/02; B65G 2812/02148

(57) ABSTRACT

An axle or shaft is of multi-part construction. Several part axles or part shafts may be arranged adjacent to one another and may be formed to be rod-shaped, part-circular, segmental, triangular or polygonal. The part axles or part shafts together may form the axle or shaft and may be arranged at a spacing from one another.

### CROSS REFERENCE TO RELATED APPLICATIONS

Applicant claims priority under 35 U.S.C. § 119 of German Application No. 10 2023 104 700.0 filed Feb. 27, 2023, the disclosure of which is incorporated by reference.

### BACKGROUND OF THE INVENTION

### 1. Field of the Invention

The invention relates to an axle or shaft.

### 2. Description of the Related Art

These shafts are frequently used for transport belts, also in machines which process foodstuffs.

For that purpose bushes on which the transport medium is guided are often mounted on the axles or shafts.

In all applications it is, in any event, essential that the shafts can be regularly cleaned and/or serviced.

However, it is not possible with known axles or shafts to also clean the intermediate space between the axle and the bushes without laborious demounting work.

### SUMMARY OF THE INVENTION

It is therefore the object of the invention to create a possibility of also making this intermediate space capable of being cleaned even in the installed state and without demounting work.

According to the invention this object is fulfilled by the axle being of multi-part construction.

It is possible for, for example, cleaning agent to be introduced between the parts of the axles and thus the intermediate space to be cleaned.

In that case it has proved particularly advantageous if several part shafts are arranged adjacent to one another.

A free space which can be used for cleaning is thereby created.

An extremely advantageous embodiment of the invention is present when the part shafts are formed to be rod-shaped, part-circular, segmental, triangular or polygonal.

Different shafts can be designed according to the respective case of use. Combinations are conceivable. Tension forces can be very satisfactorily transmitted particularly in the case of part-circular or segmental part shafts.

According to the invention it is particularly advantageous if the part shafts together form the axle or shaft.

A stable shaft or axle consisting of part shafts is thereby formed.

It has proved particularly advantageous if the part shafts are arranged at a spacing from one another.

The construction is stable by virtue of a spaced arrangement.

According to the invention it has also proved very advantageous when the part axles or part shafts are configured to be twisted or convoluted, particularly helically.

An even greater stability of the shaft in its entirety is thereby achieved. A twist running in the same direction is conceivable.

Moreover, it has proved extremely advantageous if the part shafts are connected together at least at points.

The stability of the arrangement is thus again substantially enhanced.

Moreover it has proved particularly advantageous if at least one sleeve, which is pushed onto the axle, is provided.

The sleeve can rotate on the axle and can be used as, for example, a deflection for transport belts.

In that case it has proved very advantageous if the sleeve has a circular cross-section internally.

A good capability of rotation is thereby guaranteed.

A very advantageous development of the invention is also present when the sleeve has internally a cross-section adapted to the axle.

Expanded possibilities are again created by an adapted cross-section.

According to the invention it is also very advantageous if the sleeve has internally a cross-section engaging in the axle.

By virtue of a cross-section engaging in the axle it is also possible for forces which, for example, enable drive of transport belts to be transmitted between axle and sleeve.

Moreover, according to the invention it is very advantageous if the sleeve is rotatably mounted on the axle.

Smoother running of the sleeve on the axle and thus of an exemplifying transport belt is made possible by the capability of rotation.

According to the invention it is also very advantageous if with respect to its rotatability the sleeve is mounted by friction couple on the axle.

A drive can thereby be realised.

An extremely advantageous development of the invention is also present when the sleeve is displaceably mounted on the axle.

Through displacement of the sleeve on the axle not only the axle, but also the sleeve can again be better cleaned. In addition, the sleeve can be displaced on the axle depending on use. Different combinations of sleeves on an axle can be realised.

A further very advantageous development of the invention is present when a securing device for fixing the position of the sleeve on the axle is provided.

The respective sleeve can thereby be held on the axle in a defined position.

In that case, according to the invention it has proved very advantageous if the securing device is provided to be detachable.

As a result the sleeve can be very easily displaced for, for example, cleaning. For that purpose the securing device is detached.

According to a further embodiment of the invention it is also very advantageous if the axle is statically and/or dynamically balanced.

Imbalances particularly at higher axle rotational speeds are thus avoided. The balancing can be carried out by, for example, application of balance weights to the part axles and/or to the ends of the axle. Defined drillings for local reduction of mass are equally conceivable.

A very advantageous use in accordance with the invention of an axle according to the invention is present when the axle or shaft is provided in a transport belt as a drive axle and/or guide axle or drive shaft.

Greatest possible flexibility in this use is thereby achieved.

In that case it has proved very advantageous if the axle or shaft is provided in a plant which processes foodstuffs.

Excellent capability of cleaning is important particularly in plants of that kind. This is ensured by the shaft or axle according to the invention.

Further, it has proved very advantageous if the sleeve, the axle or the shaft is configured to be capable of cleaning primarily in an intermediate space therebetween.

It is ensured by this capability of cleaning that hygiene prescriptions for foodstuffs machines can be guaranteed.

### BRIEF DESCRIPTION OF THE DRAWINGS

The invention is illustrated in the following by way of several embodiments, in which:

FIG. 1 shows an axle according to the invention with three part axles and a sleeve mounted thereon,

FIG. 2 shows a further axle according to the invention with a semi-circular and a rod-shaped part axle,

FIG. 3 shows a third variant of an axle according to the invention with three rod-shaped part axles, the outer contour of which is adapted to the circular contour of the axle in its entirety,

FIG. 4 shows a fourth variant of an axle according to the invention with three rectangular part axles, the outer contour of which is adapted to the circular contour of the axle in its entirety,

FIG. 5 shows a further illustration of the second variant with additional strengthening and a pushed-on sleeve,

FIG. 6 shows a detail illustration of the second variant according to FIG. 5,

FIG. 7 shows an illustration of a variant with twisted part axles,

FIG. 8 shows an illustration of a variant in which the part axles are screw-connected with the bearing pieces,

FIG. 9 shows an illustration of a sleeve with an inner contour adapted to the respective shaft,

FIG. 10 shows an illustration of a shaft with a sleeve adapted to the shaft contour,

FIG. 11 shows two shafts of a transport belt with different sleeves and

FIG. 12 shows a detail illustration of a shaft with different sleeves.

### DETAILED DESCRIPTION OF PREFERRED EMBODIMENTS

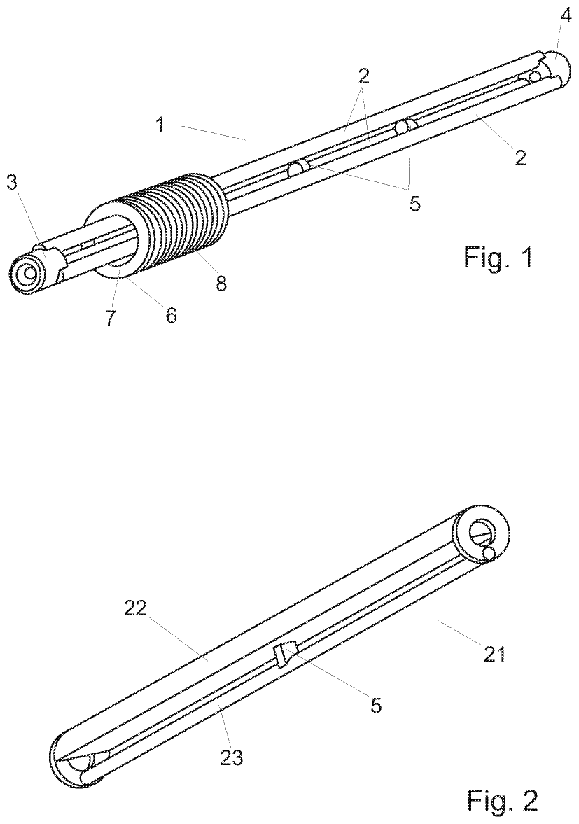

An axle constructed from three rod-shaped part axles 2, which are arranged parallel to one another and which each have a circular cross-section, is denoted by 1 in FIG. 1. These part axles 2 are connected at the ends thereof with a bearing journal 3 or 4, with the help of which the axle 1 can be rotatably or rigidly mounted in a machine arrangement.

The three part axles 2 are in that case so arranged relative to one another that these define an enveloping circular cross-section of the axle 1 in its entirety.

In this embodiment the part axles 2 are interconnected in their length dimension by two connectors 5. By virtue of this additional connection the entire axle is significantly stiffer in bending and can accept greater forces.

The part axles 2 are respectively arranged at an angle of 120° with respect to the entire axle 1 on the enveloping outer contour of the entire axle 1. Other arrangements and other numbers of part axles are conceivable.

A sleeve 6 formed with a circular inner contour 7 is arranged on the axle 1. The inner contour 7 corresponds with the outer contour of the axle 1 so that the sleeve is mounted on the axle to be free of play in radial direction.

Nevertheless, the sleeve 6 is displaceable on the axle 1.

In this embodiment the outer contour of the sleeve 6 has grooves 8, which extend over the circumference, for reception of transport belts.

Thus, overall not only can the axle 1 can rotate in its bearing, but also the sleeve 6 can rotate on the axle 1.

If a machine equipped with such an axle is now to be cleaned, it is on the one hand a simple matter to introduce cleaning agent between the part shafts 2, even on the inner side of the inner contour 7 of the sleeve 6. This is usually carried out by spraying.

In addition, the sleeve 6 can be displaced on the axle 1 in axial direction so that every area of the axle is accessible and cleanable.

In order to prevent undesired displacement of the sleeve 6 on the axle 1 it is conceivable to provide appropriate securing. This can be, for example, a clamping ring on the axle. A device at the machine side is also conceivable here. Thus, for example, there can be provided on the machine side a form of dog which engages the axial ends of the sleeve or also in the grooves and thus prevents displacement. Such a dog can, for example, be capable of being tilted away or taken off.

Instead of the three rod-shaped part axles 2 of the first variant it is also conceivable to provide, as illustrated in FIG. 2, a half-axle 22 with semi-circular cross-section and a rod-shaped part axle 23 arranged in correspondence therewith. The half-axle 22 and the part axle 23 in turn together form a circular envelope and thus the axle 1 in its entirety.

By comparison with the first embodiment such a design offers an increased locating area for the sleeve 6. Greater tension forces can therefore be accepted. However, for that purpose it can be expedient to mount the axle 21 in the machine to be secure against relative rotation so that the tension loading acts on the semi-circular section of the half-axle 22.

Here, too, reinforcements can be provided which stabilise the part axle 23 and above all also prevent vibrations.

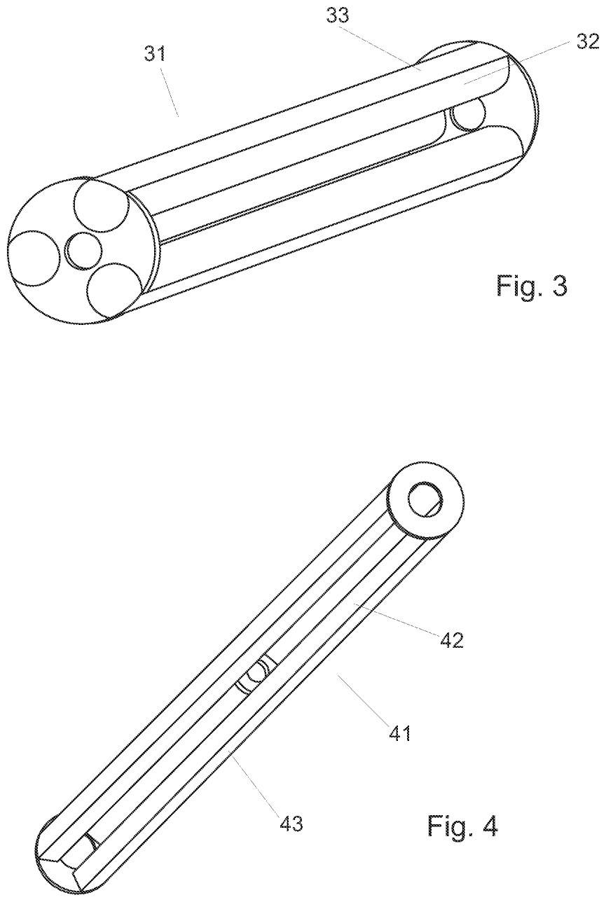

As illustrated in FIG. 3, it is also possible to provide rod-shaped part axles 32 having a contour adapted to the circular envelope of the axle 31 in its entirety. Through this adaptation the locating surface 33 of the part axles 32 is increased at the inner contour 7 of the sleeve. This is then no longer lineal, but areal, whereby greater tension and compression forces can be transmitted to the axle. Due to the lower area pressure, a lesser degree of wear is also be expected.

The capability of cleaning is not negatively influenced by that.

In that case the rod-shaped part axles 42 can also have a rectangular cross-section, wherein one side surface is adapted to the circular envelope of the axle 41 and forms a locating surface for the sleeve 6.

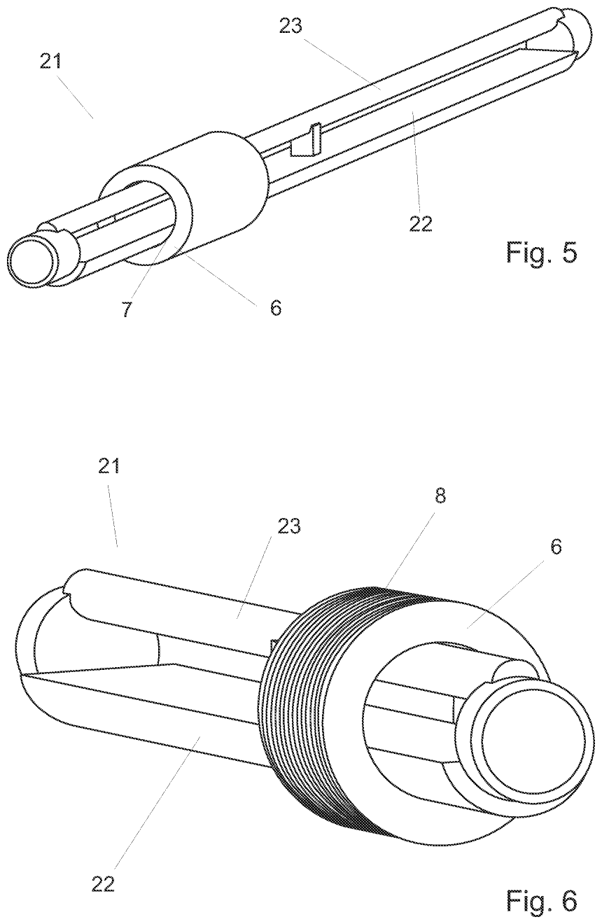

FIG. 5 shows an axle 21 according to a second embodiment with pushed-on sleeve 6. The outer side of the sleeve 6 in this case is formed to be smooth and can serve as deflection or support for transport belts.

Cleaning agent or the like can be introduced very satisfactorily between the half-axle 22 and the part axle 23 and also into the region of the sleeve 6 so that even without displacement of the sleeve 6 cleaning of the outer side of the axle 21 and the inner side 7 of the sleeve 6 can be ensured.

This is illustrated again in detail in FIG. 6, wherein here a sleeve 6 with grooves on the outer side is shown.

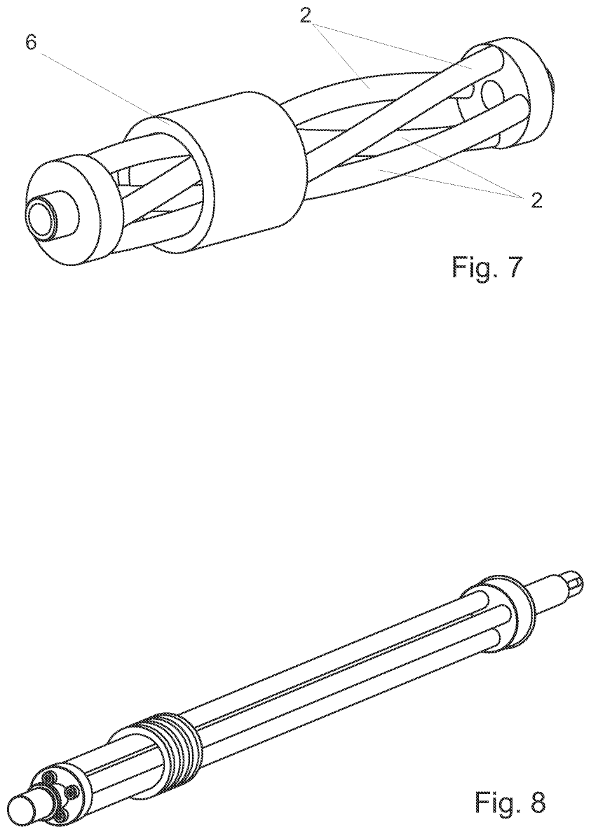

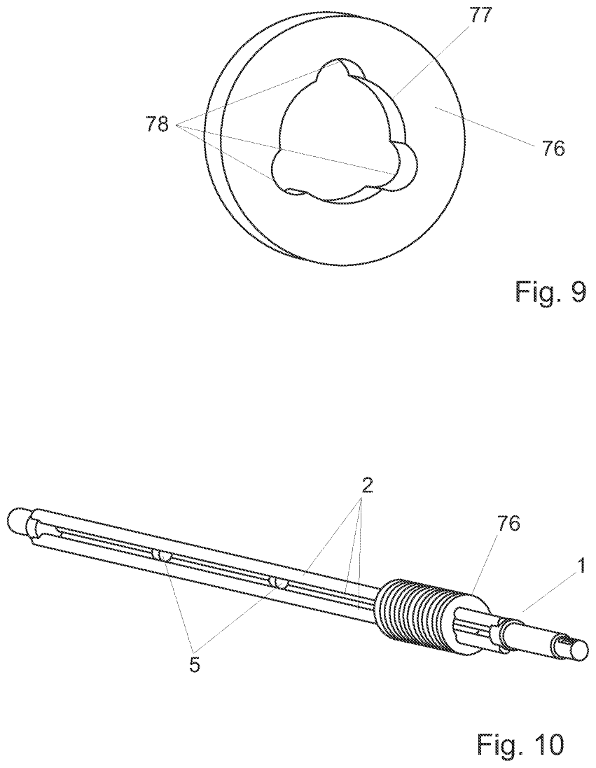

It is conceivable, as shown in FIG. 7, for the part axles—here as an example the four rod-shaped part axles 2—to be of twisted configuration and thus adopt a helical course. The stability of the axle 1 in its entirety is thereby again significantly increased. Moreover, improved location of the sleeve 6 can again be guaranteed. A twist running in the same direction, as shown in this example, is conceivable.

The axles are in that case produced by means of the most diverse production methods. All expedient joining methods are available, for example welding, soldering, laser welding, gluing, screwing or the like. As a result, on the one hand the part axles can be connected with the bearing pieces and also the reinforcements with the part axles.

An example of a screw connection is illustrated in FIG. 8.

If the axles and shafts according to the invention are to be used in high-speed applications then it can be expedient to balance the shafts statically and dynamically. This can be carried out, for example, by application of balance weights to the part axles and/or to the bearing pieces. Balance drillings for local reduction of weight are also conceivable.

However, the design of the axles in accordance with the invention also enables selectable use as shafts which can transmit torque to transport belts.

For that purpose sleeves 76 having an inner contour 77 adapted to the respective shaft are provided. In the present embodiment an adaptation to a shaft 1 with three rod-shaped part shafts 2 is shown.

The adaptation to the contour of the respective shaft includes engagement of the inner contour 77 of the sleeve 76 between the part shafts 2. For that purpose depressions 78 corresponding with the respective part shafts are provided in the inner contour 77 of the sleeve 76. However, the envelope of the inner contour 77 overall is smaller than the envelope of the outer contour of the respective shaft.

The sleeves 76 are pushed onto the shaft 1 as illustrated in FIG. 10. By virtue of the engagement of the inner contour 77 in the shaft 1, thus between the part shafts 2, torque is transmitted between the shaft 1 and the sleeve 76.

Here, too, cleaning agent can also be applied to the inner side of the sleeve 76. Through displacing the sleeve 76 the shaft 1 as well as the inner side 77 of the sleeve 76 can be very satisfactorily cleaned.

An axle shaft which can serve not only as a deflection, but also at the same time as a drive, can be created by appropriate combination of sleeves 6 and sleeves 76.

Even different speeds of the deflection and the drive are conceivable.

The configuration of such an axle shaft also does not have to be fixed beforehand. The configuration is determined exclusively by the appropriate combination of sleeves 6 and 76. For that purpose the axle shafts as well as the sleeves 6 and 76 are provided as standard parts and are then configured in correspondence with the respective purpose of use.

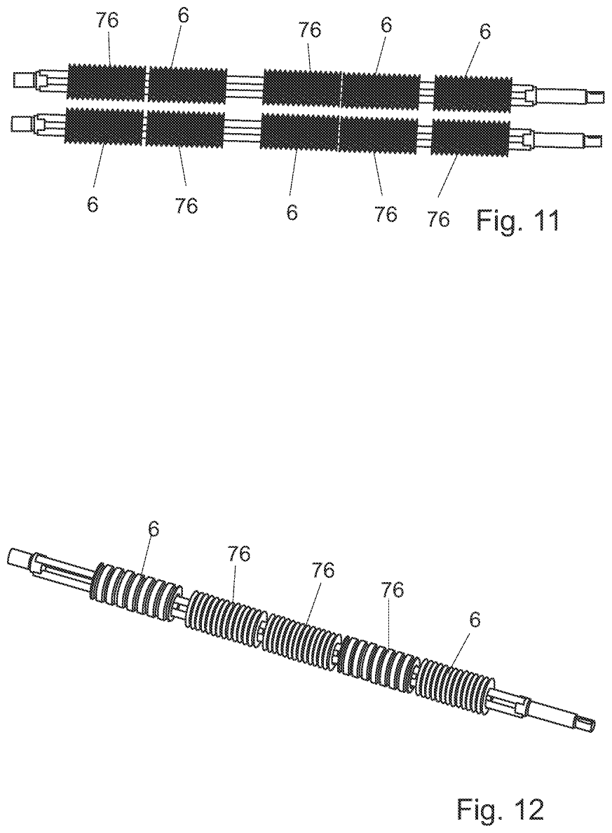

An exemplifying configuration is shown in FIGS. 11 and 12.

An axle shaft pair which is both drive shaft and deflecting axle is shown here.

Different embodiments of the individual sleeves 6 and 76, for example with respect to the outer surfaces thereof, the provided grooves 8 or the like, are conceivable.

Overall a very satisfactorily cleanable and very flexibly usable system which can guarantee the appropriate hygiene requirements particularly in foodstuffs machines is created.

1: An axle (1) or shaft, wherein the axle (1) is of multi-part construction.

2: The axle according to claim 1, wherein several part shafts (2, 22, 23, 32, 42) are arranged adjacent to one another.

3: The axle according to claim 1, wherein the part shafts (2, 22, 23, 32, 42) are formed to be rod-shaped, part-circular, segmental, triangular or polygonal.

4: The axle according to claim 1, wherein the part shafts (2, 22, 23, 32, 42) together form the axle (1, 21, 31) or shaft.

5: The axle according to claim 1, wherein the part shafts (2, 22, 23, 32, 42) are arranged at a spacing from one another.

6: The axle according to claim 1, wherein the part axles (2, 22, 23, 32, 42) or part shafts are formed to be twisted or convoluted, particularly helically.

7: The axle according to claim 1, wherein the part shafts (2, 22, 23, 32, 42) are connected together at least at points.

8: The axle according to claim 1, wherein at least one sleeve (6, 76), which is pushed onto the axle (1, 21, 31, 41), is provided.

9: The axle according to claim 1, wherein the sleeve (6) has a circular cross-section internally.

10: Ax The axle according to claim 1, wherein the sleeve (76) has internally a cross-section adapted to the axle.

11: The axle according to claim 1, wherein the sleeve (76) has internally a cross-section engaging in the axle.

12: The axle according to claim 1, wherein the sleeve (6) is rotatably mounted on the axle (1, 21, 31, 41).

13: The axle according to claim 1, wherein with respect to its rotatability the sleeve (6) is mounted by friction couple on the axle (1, 21, 31, 41).

14: The axle according to claim 1, wherein the sleeve (6) is displaceably mounted on the axle (1, 21, 31, 41).

15: The axle according to claim 1, wherein a securing device for fixing the position of the sleeve (6, 76) on the axle (1, 21, 31, 41) is provided.

16: The axle according to claim 15, wherein the securing device is provided to be detachable.

17: The axle according to claim 1, wherein the axle (1, 21, 31, 41) is statically and/or dynamically balanced.

18: A transport belt comprising the axle or shaft according to claim 1, wherein the axle (1, 21, 31, 41) or shaft is a drive axle and/or a guide axle or a drive shaft.

19: A plant which processes foodstuffs comprising the transport belt according to claim 18.

20: The transport belt according to claim 18, wherein the sleeve (6, 76), the axle (1, 21, 31, 41) or the shaft is configured to be capable of cleaning primarily in an intermediate space therebetween.
